(19) United States
(12) Patent Application Publication
(10) Pub. No.: US 2024/0076784 A1
(43) Pub. Date: Mar. 7, 2024

(54) INTEGRATED AMMONIA PRODUCTION WITH ENERGY CAPTURE

(71) Applicant: Schlumberger Technology Corporation, Sugar Land, TX (US)

(72) Inventors: David Snoswell, Cambridge (GB); Marcus Jesen, New Plymouth (NZ)

(21) Appl. No.: 18/459,457

(22) Filed: Sep. 1, 2023

Related U.S. Application Data
(60) Provisional application No. 63/403,072, filed on Sep. 1, 2022.

(51) Int. Cl. C25B 1/27; C25B 15/021; C25B 15/08

(52) U.S. Cl. CPC C25B 1/27; C25B 15/021; C25B 15/08

(57) ABSTRACT

An ammonia production system includes a steam generation device configured to produce steam and an electrolyzer cell configured to produce hydrogen feedstock gas from the steam. A hydrogen combustor receives the hydrogen feedstock gas from the electrolyzer cell and combusts the hydrogen feedstock gas and produce heat and electricity. A combustion thermal conduit provides heat transfer between the hydrogen combustor and the steam generation device. An electrical generator is connected to the hydrogen combustor and configured to generate electricity.

### CROSS-REFERENCE TO RELATED APPLICATIONS

This application claims priority to and the benefit of United States Provisional Patent Application No. 63/403,072, filed on Sep. 1 2022, which is hereby incorporated by reference in its entirety.

### BACKGROUND

Production of ammonia, using the Haber-Bosch process has been widely practiced, and is currently the dominant production method of ammonia for fertilizer, and agriculture, with an emerging transition into the fuel market as a stable, transportable compound for hydrogen. The Haber-Bosch process relies on two feedstock gasses, nitrogen, and hydrogen. Steam-methane reforming (SMR) and water-gas shift (WGS) reactions are often used to produce a hydrogen feedstock where CO₂ is a by-product. Nitrogen is extracted from air by either membrane separation, cryogenic distillation, or pressure swing adsorption.

The nitrogen and hydrogen are then fed at a stoichiometric ratio to the Haber-Bosch reactor. An iron catalysed reaction occurs at high pressures and temperatures (˜450° C./300 bar), producing a yield of ammonia between 10-15% per pass. Unreacted H2 and N2 are recycled to the reactor feed. The forward reaction is exothermic (approximately −46 kJ/mol), providing additional heat, that is either reused or lost to atmosphere.

The Haber-Bosch process remains the dominant and most economical source of ammonia production, however Carbon Dioxide emissions from steam methane reforming are significant, over 1% of global emissions.

### SUMMARY OF THE DESCRIPTION

In some embodiments, an ammonia production system includes a steam generation device configured to produce steam and an electrolyzer cell configured to produce hydrogen feedstock gas from the steam. A hydrogen combustor receives a portion of the hydrogen feedstock gas from the electrolyzer cell and combusts the hydrogen feedstock gas and produce heat and electricity. A combustion thermal conduit provides heat transfer between the hydrogen combustor and the steam generation device. An electrical generator is connected to the hydrogen combustor and configured to generate electricity.

In some embodiments, a method of producing ammonia includes producing steam with a steam generation device; delivering the steam to an electrolyzer cell; electrolyzing the steam to form hydrogen gas; providing hydrogen gas from the electrolyzer cell to a hydrogen combustor; combusting the hydrogen gas with air to produce nitrogen feedstock, water, electricity, and heat; recycling the heat to the steam generation device; and recycling the electricity to the electrolyzer cell.

In some embodiments, a system for ammonia production includes a thermal energy generation cycle, a steam generation device, and an electrolyzer cell. The thermal energy generation cycle is configured to produce electricity. The steam generation device is configured to produce steam. The electrolyzer cell is configured to produce hydrogen feedstock gas from the steam. A hydrogen combustor is configured to receive at least a portion of the hydrogen feedstock gas from the electrolyzer cell and combust the hydrogen feedstock gas and produce nitrogen feedstock gas, steam, heat, and electricity. A first combustion thermal conduit provides thermal transfer between the hydrogen combustor and the steam generation device. A second combustion thermal conduit that provides thermal transfer between the hydrogen combustor and the thermal energy generation cycle. An electrical generator is connected to the hydrogen combustor and configured to generate electricity. An ammonia reactor is configured to receive the hydrogen feedstock gas and the nitrogen feedstock gas. Pressurized combustor exhaust containing steam and nitrogen is separated by condensing the steam, a thermal conduit from the steam condenser provides additional thermal transfer to the steam generator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

FIG. 1 is a system diagram of an ammonia production system, according to at least one embodiment of the present disclosure.

FIG. 2 is a flowchart of a method of ammonia production, according to at least one embodiment of the present disclosure.

FIG. 3-1 is a system diagram of an ammonia production system with a shared thermal storage device, according to at least one embodiment of the present disclosure.

FIG. 3-2 is a schematic diagram of an ammonia production system with dedicated thermal storage devices, according to at least one embodiment of the present disclosure.

FIG. 4 is a schematic diagram of thermal storage device, according to at least one embodiment of the present disclosure.

FIG. 5 is a schematic diagram of condenser and separator in an ammonia production system, according to at least one embodiment of the present disclosure.

FIG. 6 is a schematic diagram of a compression train in an ammonia production system, according to at least one embodiment of the present disclosure.

### DETAILED DESCRIPTION

Embodiments of the present disclosure relate to methods for producing ammonia through a Haber-Bosch reaction. More particularly, some embodiments relate to ammonia production using energy recapture through both electricity and heat. More particularly still, some embodiments relate to electricity and heat recapture and recycling from a hydrogen combustor to one or more stages of the ammonia production process. For example, a hydrogen combustor can combust a portion of the available hydrogen in combination with air to produce heat, electricity, water and a nitrogen feedstock. The heat and electricity from the nitrogen feedstock production can be recycled back to a renewable energy source or to a solid-oxide electrolysis cell (SOEC) to produce energy or reduce energy consumption. The combustion of hydrogen in the presence of air produces water. In some embodiments, the water is further recycled from the combustion exhaust to a steam generator to be electrolyzed in the SOEC.

While embodiments of the present disclosure discuss the electrolysis of water using an SOEC that produce hydrogen from steam and is therefore generally coupled with a steam generation device, it should be understood that electrolysis may occur using any type of electrolysis system, including high-temperature electrolysis systems, low-temperature electrolysis systems, high-pressure electrolysis systems, low-pressure electrolysis systems, and combinations thereof. Some of the electrolysis systems above produce hydrogen from liquid water and such system may therefore not include a steam generation device. Examples of electrolysis systems include a Hofmann voltameter, alkaline water electrolysis, a proton exchange membrane, supercritical water, nickel/iron electrolysis, nanogap electrochemical cells, a capillary fed electrolyzer cell, proton exchange membrane (PEM) electrolysis, any other electrolysis system, and combinations thereof. In some embodiments, as discussed herein, electrolysis may be performed using water purified with a desalination system.

In some embodiments, an ammonia production system reacts hydrogen feedstock (e.g., H₂) with a nitrogen feedstock (e.g., N₂) to produce ammonia (NH₃) in a reactor at an elevated temperature. For example, the reaction may be conducted at pressures above 10 MPa (100 bar; 1,450 psi) and between 400 and 500° C. (752 and 932° F.). In some embodiments, the gases (nitrogen and hydrogen) are passed over beds of catalyst, with cooling between each pass for maintaining a reasonable equilibrium constant. In some examples, a partial conversion is achieved on each pass (e.g., about 15% conversion), but any unreacted gases are recycled through the reactor, and eventually an overall conversion of 97% of feedstock gases can be achieved. In some embodiments, the catalyst consists of iron bound to an iron oxide carrier containing promoters such as aluminium oxide, potassium oxide, calcium oxide, potassium hydroxide, molybdenum, magnesium oxide, other materials, or combinations thereof.

Producing the feedstock gases for the reaction conventionally requires an external power source and can consume electricity. Some embodiments of ammonia production systems according to the present disclosure can capture and recycle heat and electricity from within the system to reduce energy consumption. Some embodiments of ammonia production systems according to the present disclosure can include variable renewable energy (VRE) sources or imported off-peak electricity to further reduce carbon by-products of the system. In some embodiments, electricity and/or heat from the system is recycled to the VRE sources to further reduce energy consumption of the system.

In a conventional ammonia production system, nitrogen feedstock gas is produced through either membrane separation, cryogenic distillation or pressure swing adsorption, which all consume electricity to produce the nitrogen feedstock. In some embodiments according to the present disclosure, a hydrogen combustor is used to combust hydrogen gas in the presence of air to produce a nitrogen/water mix from which a nitrogen feedstock via an exothermic reaction. In some examples, heat from the exothermic reaction is recycled to vaporize water (in preparation for steam electrolysis). In some examples, the exothermic reaction can drive a turbine or internal combustion engine to produce electricity, which is used to power the electrolysis of the water. The heat and electricity by-products of the hydrogen combustion can, thereby, offset at least a portion of the energy consumed during production of the nitrogen feedstock. Water can also be recovered from the combustion exhausted and fed into the steam generator.

In other examples, heat from the hydrogen combustor can be recycled to the ammonia reactor (i.e., the Haber-Bosch reactor) to produce the elevated temperatures for the Haber-Bosch reaction, such as with an adsorber that adsorbs ammonia for storage and releases the ammonia through applied heat. In yet other examples, heat from the hydrogen combustor can be recycled to a VRE source, such as a low-temperature (e.g., 90° C. or less) solar thermal generator to assist in producing electricity for the ammonia production system. In yet further examples, waste heat from the Haber-Bosch reaction can be recycled to vaporize water for electrolysis and/or for electricity production in a VRE source.

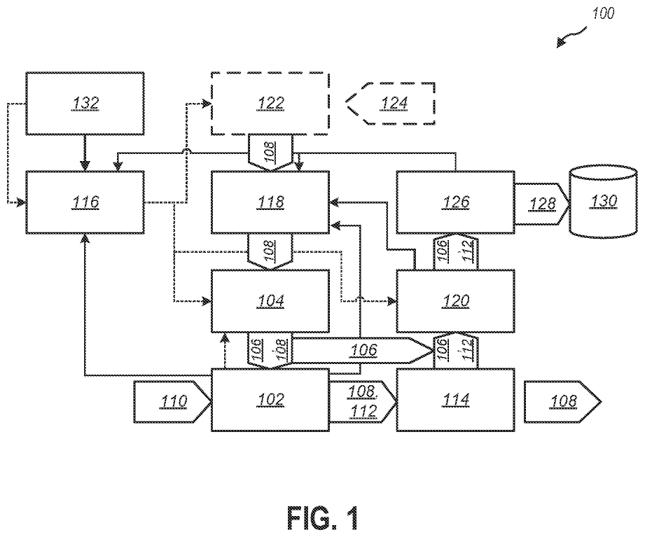

FIG. 1 is a system diagram illustrating an embodiment of an ammonia production system 100 according to the present disclosure. FIG. 1 also illustrates an embodiment of mass flow (block arrows), heat flow (solid arrows), and electricity flow (dashed arrows) in an ammonia production system 100 that captures and recycles energy to reduce cost and reduce energy consumption from external sources. The ammonia production system 100 includes a hydrogen combustor 102. A solid-oxide electrolysis cell (SOEC) 104 provides hydrogen (H₂) feedstock 106 and water vapor (H₂O) to the hydrogen combustor 102. The hydrogen combustor 102 combusts at least a portion of the hydrogen feedstock 106 with air 110 in an exothermic reaction to produce heat, water vapour and a nitrogen feedstock, as well as electricity as will be explained herebelow. The combustion results in products including nitrogen feedstock 112 that is exhausted with water 108 to a condenser 114. In some embodiments, the condenser 114 condenses and removes at least a portion of the water 108 from the input gases (e.g., the nitrogen feedstock 112 and water 108). The water 108 condensed by the condenser 114 may be recycled elsewhere in the ammonia production system 100 such as back to the steam generator 118.

In some embodiments, the hydrogen combustor 102 includes a turbine generator that converts an expansion of the combustion reaction into electricity through the rotation of a shaft coupled to the turbine(s). In some embodiments, the hydrogen combustor 102 includes an internal combustion generator that converts an expansion of the combustion reaction within one or more cylinders into electricity through the rotation of a shaft coupled to a piston moveable within the cylinder(s). The hydrogen combustor 102 may convert the expansion of the gases during the combustion reaction into electricity in any relevant manner.

The heat produced by the hydrogen combustor 102, in some embodiments, is provided to one or more of a thermal power generation cycle 116, a steam generator 118, or other components of the ammonia production system 100. The heat from the hydrogen combustor 102 is provided to the thermal power generation cycle 116, steam generator 118, or other component to reduce the amount of energy consumed to heat the respective components. For example, a steam generator 118 may use resistive heating that consumes electricity to heat one or more heating elements through a resistance in the heating element, which dissipates at least a portion of the electrical power as heat. Resistive heating can consume a large amount of electricity. Using waste heat from other components of the ammonia production system 100, such as the hydrogen combustor 102, can reduce and/or eliminate the electricity consumption of the steam generator 118.

In other examples, a thermal power generation cycle 116 may use heat to generate electricity and may be for instance an Organic Rankine Cycle. Such thermal cycle may allow waste heat from the hydrogen combustor 102 and/or other components of the ammonia production system 100 to be converted into electricity. For example, the electricity produced by the thermal power generation cycle 116 may be provided to the SOEC 104.

In some embodiments, electricity is further provided to a compression train 120 that compresses one or more feedstock gases (e.g., hydrogen feedstock 106 and nitrogen feedstock 112). In FIG. 1, the feedstock gases are illustrated in a single mass flow from the SOEC 104 and the condenser 114, and the feedstock gases may be compressed in the compression train 120 together in a shared volume. In some embodiments, the feedstock gases may be compressed in separate compression trains 120. For example, the compressibility of the feedstock gases may be different, and different quantity of compression steps or different compression ratios at each compression steps may be different for the different feedstock gases. As will be described herein, in some embodiments, a compression train 120 according to the present disclosure may maintain a temperature of the feedstock gases above a selected temperature to allow recycling of heat from the compressor(s) of the compression train 120 to the steam generator 118 or other components of the ammonia production system 100.

In some embodiments, the SOEC 104 produces hydrogen feedstock 106 from water 108 that is supplied by a steam generator 118. The steam generator 118 heats the water 108 above the boiling temperature to produce steam that is provided to the SOEC 104. In some embodiments, the steam generator 118 includes resistive heating elements to heat the water. In some embodiments, the steam generator 118 heats the water with a heat pump. In some embodiments, the steam generator 118 consumes less energy than a conventional ammonia production system by recycling at least a portion of the heat produced elsewhere in the ammonia production system 100 to heat and/or vaporize the water.

In some embodiments, the ammonia production system 100 further includes a desalination device 122. For example, the desalination device 122 may receive input water 124 from a water source that needs to be purified, such as ocean water or underground water, and desalinate the water for use in the ammonia production system 100. In some embodiments, such as illustrated in FIG. 1, the desalination device 122 provides water 108 to the steam generator 118 to produce steam that is more easily electrolyzed by the SOEC 104. In some embodiments, desalinated water is used to fill an energy storage system, provided a coolant in heat exchange cycles, provide water to the thermal power generation cycle 116, provide water to the steam generator 118, provide water to the electrolyzer (especially if the electrolyzer is not a high temperature electrolyzer) or combinations thereof. Desalination to the target requirement of SOEC's has a significant energy requirement that can be delivered by a VRE source 132, from the thermal power generation cycle 116, through supplemental heat recycled from other components of the ammonia production system 100, or combinations thereof. Thermal desalination may be performed using a flash desalination process (i.e., heating water past its boiling point) or any other suitable process known from the one of ordinary skill. Thermal desalination is, therefore, an opportunity to recycle heat from thermal storage or other components of the ammonia production system 100 to provide at least a portion of the required energy load for desalination.

For example, there are 2 methods that can be integrated into a combined progress, which each provide additional energy efficiency through the use of either heat or electricity. The specific VRE source 132 may affect the amount of heat recycled to the desalination. In some examples, the VRE source 132 may be a concentrated solar thermal generated provide both electricity (from photovoltaic cells) and heat (collected waste heat from the photovoltaic cells) and, as the balance of generation from a concentrated solar thermal generator shifts toward more electricity, or more thermal capacity per square-meter of ‘receiver area, a surplus of either may emerge. A future increase in photovoltaic efficiency may favor more electricity, driving the use of a more economical reverse osmosis (RO) processes. If the thermal tolerance of photovoltaic cells improves at a proportionally higher rate in the future, an increase in temperature and heat load may favor thermal (flash) desalination via evaporation.

After producing the hydrogen feedstock 106 and the nitrogen feedstock 112, an ammonia production system 100 may include an ammonia reactor 126 (such as a Haber-Bosch reactor) or other reactor to produce ammonia 128. The ammonia 128 may then be delivered to an ammonia storage device 130 for distribution, packaging, further treatment, or combination with other produces.

In some embodiments, the ammonia 128 is the final product of the ammonia production system 100. For example, the ammonia can be exported or combusted to generate energy on demand for the process or network electricity demand. In some embodiments, the ammonia production system 100 is part of a production system for another product, and the ammonia 128 is provided as a part of another product.

In some embodiments according to the present disclosure, only the Haber-Bosch synthesis loop is required, with nitrogen feedstock 112 and hydrogen feedstock 106 fed by the SOEC 104 and hydrogen combustor 102 and the heating and compression train 120 powered by the VRE source 132.

The ammonia reactor 126, in some embodiments, produces heat that is recycled to other components of the ammonia production system 100. In some embodiments, an exothermic reaction across an iron-based catalyst bed creates a high temperature discharge stream from the reactor. This high temperature heat source at ˜500° C. discharged from the reactor is recycled into the working fluid in the thermal cycle 116, as superheat, with the residual heatload used for preheating the compressed feedstock (e.g., nitrogen feedstock 112 and hydrogen feedstock 106) stream from the compression train 120 to the ammonia reactor 126. Further cooling requirements for the nitrogen feedstock 112, hydrogen feedstock 106, and ammonia 128 stream(s) are provided by a low temperature chiller, with the rejected heat returned to a thermal (hot) storage system. Including a thermal storage system in the system further improves the exchange efficiency.

In some embodiments, ammonia is separated through a multistage separator in or after the ammonia reactor 126, which allows nitrogen feedstock 112 and hydrogen feedstock 106 to be recycled back into the compression train 120, for reprocessing. The typical single pass Haber-Bosch reactor yield is between 12 and 18%. Further development of catalysts may improve the yield value further. Further advances in both Haber-Bosch reactors and water electrolysis provide further efficiency gains to drive down the levelized cost of ammonia according to the present disclosure. The utilization of the exothermic heat recycled back into the thermal power generation cycle 116 and other components of the ammonia production system 100 to boost efficiency of the ammonia production system 100 allows less system energy consumption and lower cost of operations compared to a conventional Haber-Bosch synthesis loop production system.

In some embodiments, heat is recycled from a heat source component to a heat sink component in the ammonia production system 100 directly through a thermal conduit. A heat source component is any component of the ammonia production system 100 that produces heat and/or has heat produced therein during operation, such as by an exothermic reaction or electrical conversion, such as an alternating current (AC) to direct current (DC) convertor. For example, a heat source component includes the hydrogen combustor 102, the compression train 120, the ammonia reactor 126, and the VRE source 132. A heat sink component is any component of the ammonia production system that receives heat or consumes heat during operation. For example, a heat sink component includes the steam generator, the thermal energy generation cycle 116, and the desalination device 122. In some examples, a component may selectively be a heat source component and/or a heat sink component, such as the ammonia reactor 126 which can be heated prior to a Haber-Bosch cycle but also produces heat through the exothermic reaction. In some embodiments, the ammonia reactor 126 can receive heat to preheat the ammonia reactor during load changes 126 and then export heat when the exothermic reaction is stabilised.

In some embodiments, the heat is transferred from a heat source component to a heat sink component through a thermal conduit that conducts heat and/or transfers heat through a mass flow. For example, some thermal conduits may be a solid-state thermal conduit that conduct heat through thermally conductive solid mass, such as a rod or sheet between the heat source component and the heat sink component. In some examples, the thermal conduit is a solid copper conduit. In other examples, some thermal conduits may be a fluid-based conduit that flows a working fluid through and/or in at least a portion of the conduit to move heat from the heat source component and the heat sink component. For example, the working fluid may be water. In other examples, particularly those transferring heat from a heat source component with a temperature above the boiling temperature of water, the working fluid may be a different working fluid with a higher boiling temperature to allow the working fluid to remain liquid while transferring heat. In yet other examples, the working fluid may be a multi-phase working fluid that changes physical state during the heat transfer process. As the latent heat of boiling allows the working fluid to receive additional heat without an associated increase in temperature, a multi-phase working fluid can further increase the heat transfer efficiency of a thermal conduit.

In some embodiments, one or more of the thermal conduits that move heat from a heat source component to a heat sink component is a dedicated conduit. For example, the thermal conduit is configured to move heat only from a heat source component to a heat sink component. In some embodiments, one or more of the thermal conduits that move heat from a heat source component to a heat sink component is a shared conduit. For example, the thermal conduit is configured to transfer heat from a plurality of heat source components to a single heat sink component, from a single heat source component to a plurality of heat sink components, or from a plurality of heat source components to a plurality of heat sink components.

In some embodiments, heat is recycled from a heat source component to a heat sink component in the ammonia production system 100 indirectly through a thermal storage device. For example, a thermal storage device may be positioned in or along any of the thermal conduits (e.g., illustrated as heat transfer lines illustrated in FIG. 1) that receives heat from a heat source component and stores the heat for subsequent transfer to a heat sink component. In some embodiments, one or more thermal storage devices are dedicated thermal storage devices. For example, the dedicated thermal storage device is positioned in or along a dedicated thermal conduit. In some embodiments, one or more thermal storage devices are shared thermal storage devices. For example, the shared thermal storage device is positioned in or along a shared thermal conduit.

One or more electrical conduits, in some embodiments, are configured to provide electrical communication between an electrical source component and an electrical sink component. In some embodiments, one or more of the electrical conduits that move electricity from an electrical source component to an electrical sink component is a dedicated conduit. For example, the electrical conduit is configured to provide electricity only from an electrical source component to an electrical sink component. In some embodiments, one or more of the electrical conduits that conduct electricity from the electrical source component to the electrical sink component is a shared electrical conduit. For example, the electrical conduit is configured to transfer electricity from a plurality of electrical source components to a single electrical sink component, from a single electrical source component to a plurality of electrical sink components, or from a plurality of electrical source components to a plurality of electrical sink components.

In some embodiments, electricity is recycled from an electrical source component to an electrical sink component in the ammonia production system 100 indirectly through an electrical storage device (e.g., a battery, a capacitor, other electrical storage devices, or combinations thereof). For example, an electrical storage device may be positioned in or along any of the electrical conduits (e.g., illustrated as electrical transfer lines illustrated in FIG. 1) that receives electricity from an electrical source component and stores the electricity for subsequent transfer to an electrical sink component. In some embodiments, one or more electrical storage devices are dedicated electrical storage devices. For example, the dedicated electrical storage device is positioned in or along a dedicated electrical conduit. In some embodiments, one or more electrical storage devices are shared electrical storage devices. For example, the shared electrical storage device is positioned in or along a shared electrical conduit.

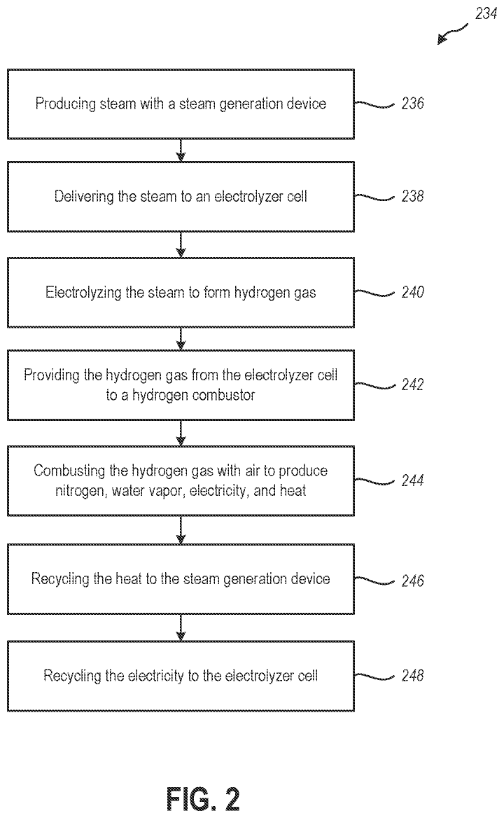

FIG. 2 is a flowchart of an embodiment of a method 234 of ammonia production. In some embodiments, the method 234 includes producing steam with a steam generating device at 236 and delivering the steam to an electrolyzer cell at 238. In some embodiments, the electrolyzer cell is a SOEC such as described in relation to FIG. 1. The method further includes electrolyzing the steam to form hydrogen gas at 240. In some embodiments, the steam is not fully converted into hydrogen gas and oxygen gas, and at least a portion of the water remains in the electrolyzer cell. The unreacted water may be removed when the other gases are removed from the electrolyzer cell, or the unreacted water may remain in or be recycled back into the electrolyzer cell for further processing.

The method 234 further includes providing the hydrogen gas from the electrolyzer cell to a hydrogen combustor at 242 and combusting the hydrogen gas with air to produce nitrogen, water vapor, electricity, and heat at 244. In some embodiments, providing the hydrogen gas to the hydrogen combustor includes dividing the hydrogen gas produced in the electrolyzer cell into a first stream directed to the hydrogen combustor and a second stream directed to a compression train. For example, the first stream of hydrogen gas to the hydrogen combustor may include approximately 50% of the hydrogen gas produced by the electrolyzer cell, while the second stream of hydrogen gas to the compression train includes the remaining approximately 50% of the hydrogen gas. In other examples, the first stream of hydrogen gas to the hydrogen combustor may include less than 50%, such as approximately 15%, of the hydrogen gas produced by the electrolyzer cell, while the second stream of hydrogen gas to the compression train includes the remaining hydrogen gas, such as approximately 85% of the hydrogen gas. In yet other examples, the first stream of hydrogen gas to the hydrogen combustor may include greater than 50%, such as approximately 70%, of the hydrogen gas produced by the electrolyzer cell, while the second stream of hydrogen gas to the compression train includes the remaining hydrogen gas, such as approximately 30% of the hydrogen gas.

In some embodiments, combusting the hydrogen gas with air occurs in a hydrogen combustor including or coupled to an electrical generator that converts an expansion caused by the combustion into electricity. In some examples, the electrical generator converts the expansion into electricity through the expansion rotating a turbine. In some examples, the electrical generator converts the expansion into electricity through the expansion moving pistons that rotate a shaft. The rotation of the turbine and/or shaft can be converted to electricity to produce the electricity.

After the nitrogen, water vapor, electricity, and heat are produced at 244, the method 234 includes recycling at least a portion of the heat to the steam generation device at 246 and recycling at least a portion of the electricity to another component of the system such as the electrolyzer cell at 248. In some embodiments, recycling the heat to the steam generation device includes transferring the heat through a combustion thermal conduit from the hydrogen combustor to the steam generation device. For example, the combustion thermal conduit may be a dedicated conduit. In other examples, the combustion thermal conduit may be a shared conduit that receives heat from the hydrogen combustor. In yet other examples, the combustion thermal conduit may be a shared thermal conduit that provides heat to the steam generator from at least the hydrogen combustor. In some embodiments, the combustion thermal conduit includes a thermal storage device in or along the combustion thermal conduit that allows heat to be transferred from the hydrogen combustor to the thermal storage device. The thermal storage device may store the heat from the hydrogen combustor for at least some period of time before releasing the heat to the steam generator device.

In some embodiments, recycling at least a portion of the electricity to other component of the system such as the electrolyzer cell at 248 includes transferring the heat through a combustion electrical conduit from the hydrogen combustor (and/or the electrical generator associated therewith) to the electrolyzer cell. For example, the combustion electrical conduit may be a dedicated electrical conduit. In other examples, the combustion electrical conduit may be a shared electrical conduit that receives electricity from the hydrogen combustor and/or electrical generator. In yet other examples, the combustion electrical conduit may be a shared electrical conduit that provides electricity to the electrolyzer cell from at least the hydrogen combustor and/or electrical generator. In some embodiments, the combustion electrical conduit includes an electrical storage device in or along the combustion electrical conduit that allows electricity to be transferred from the hydrogen combustor and/or electrical generator to the electrical storage device. The electrical storage device may store the electricity from the hydrogen combustor and/or electrical generator for at least some period of time before releasing the electricity to the electrolyzer cell.

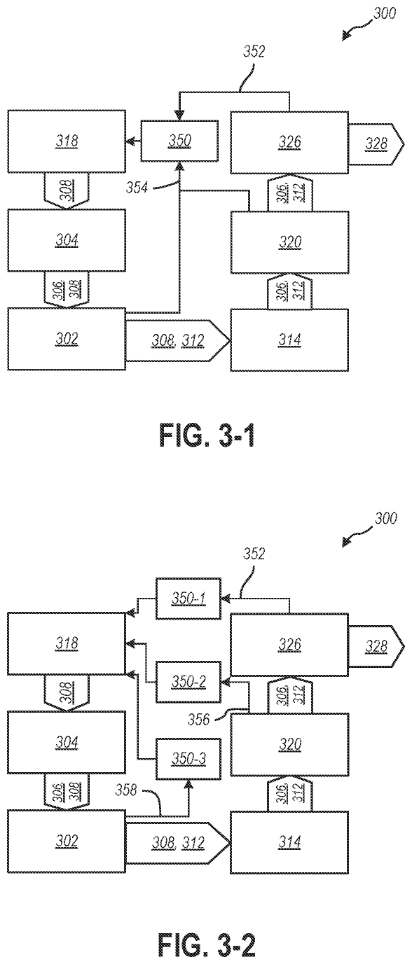

In some embodiments, the thermal storage device receives heat from a plurality of heat source components, such as illustrated in FIG. 3-1. FIG. 3-1 illustrates an embodiment of a portion of an ammonia production system 300 with a shared thermal storage device 350 that receives heat from a reactor thermal conduit 352 and a shared conduit 354 that provides heat from the hydrogen combustor 302 and the compression train 320. The thermal storage device 350 can store the heat and selectively transfer the heat to the steam generation device 318 to heat another component of the system, such as the steam generation device 318 and reduce and/or eliminate energy consumption by said component. The steam generation device 318 can then provide the steam (e.g., water 308) to the SOEC 304, which provides the hydrogen feedstock 306 to the hydrogen combustor 302. The resulting nitrogen feedstock 312 is provided to the condenser 314 and/or the compression train 320 which compress the feedstock gases before the ammonia reactor 326 that produces the ammonia 328.

In some embodiments, a plurality of thermal storage devices receive and distribute heat through the ammonia production system, allowing heat flow to be managed in response to demand, such as illustrated in FIG. 3-2. In FIG. 3-2, the illustrated embodiment includes a first thermal storage device 350-1 configured to receive heat from the reactor thermal conduit 352, a second thermal storage device 350-2 configured to receive heat from the compressor thermal conduit 356, and a third thermal storage device 350-3 configured to receive heat from the combustion thermal conduit 358. Each dedicated thermal storage device 350-1, 350-2, 350-3 can selectively provide heat to the steam generation device 318 independently. In the illustrated embodiment, the thermal conduits transferring heat from the thermal storage devices 350-1, 350-2, 350-3 and to the thermal storage devices 350-1, 350-2, 350-3 are each dedicated thermal conduits.

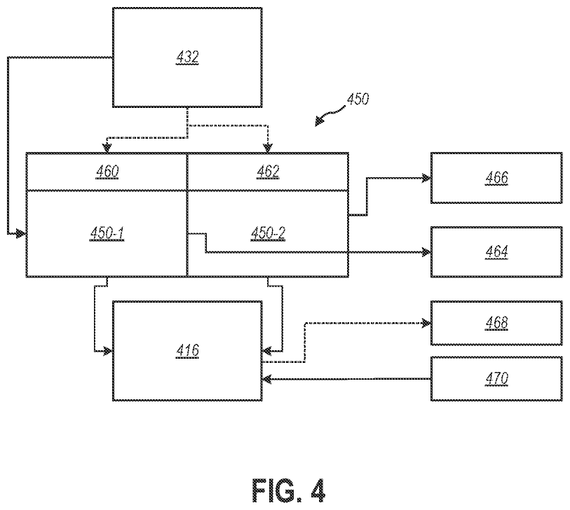

FIG. 4 is a detailed flowchart illustrating an embodiment of thermal storage device 450 and management in relation to a thermal energy generation cycle 416, such as thermal energy generation cycle 116 of FIG. 1. In some embodiments, a thermal storage device 450 of the ammonia production system includes both a high temperature thermal storage device 450-1 and a low temperature thermal storage device 450-2. For example, the low temperature thermal storage device 450-2 may be cooled through a chiller 462, utilizing the energy generation from either the solar thermal generator, photovoltaic panels, wind, or other VRE Source 432, or imported off-peak electricity. Storage as chilled water, ice slurry, solid storage, or a phase change materials allows the recovery of the stored energy (i.e., heat sink) on demand.

In removing heat from the chilled fluid, the reject heat can be recovered through a heat pump 460 or other heat exchange mechanism and also delivered to the high temperature thermal storage device 450-1, as illustrated in FIG. 4. Stored heat can be directly exported to heat sink components 464 such as desalination, steam generation, SOEC heating, and reactor pre-heating. Stored chilled solid/fluid/gas can be exported and applied directly in thermal management components 466 within the ammonia production system, such as cooling, condensing, and compression applications.

The thermal energy generation cycle 416, in some embodiments, produces electricity to power one or more electrical loads 468 in the ammonia production system by converting imported heat 470 from the high temperature thermal storage device 450-1, from other heat source components in the ammonia production system, or from VRE sources 432 such as a solar thermal generator. For example, the thermal energy generation cycle 416 may be a low-temperature thermal energy generation cycle (e.g., a Rankine cycle) that operates with an operating temperature of no more than 100° C. In some embodiments, a low temperature thermal energy generation cycle allows for electricity to be generated from recycled heat. The thermal energy generation cycle 416, in some embodiments, produces electricity based on a temperature difference between a hot portion heated, at least partially, by the imported heat 470 (such as from the high temperature thermal storage device 450-1) and a cold portion chilled by, at least partially, the low temperature thermal storage device 450-2. The thermal storage device(s) may, thereby, allow selective distribution of high or low temperatures to adjust electricity production.

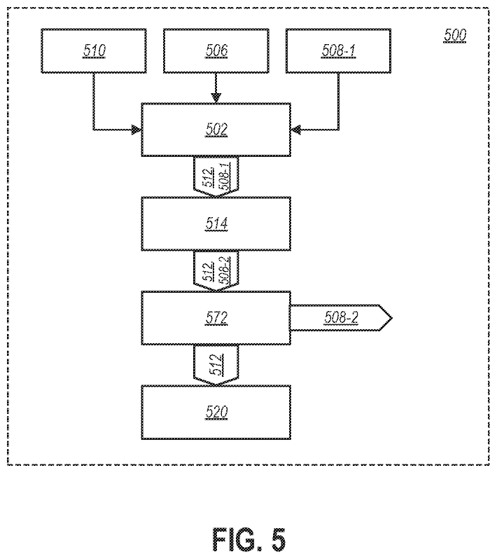

FIG. 5 is a system diagram of an embodiment of part of an ammonia production system 500 with a condenser 514 configured to condense vapor phase water 508-1 into liquid phase water 508-2 and a separator 572 to recycle liquid phase water 508-2 to one or more components of the ammonia production system 500. In some embodiments, air 510, hydrogen feedstock 506, and vapor phase water 508-1 are provided to the hydrogen combustor 502. For example, the hydrogen feedstock 506 and the vapor phase water 508-1 may be provided by the SOEC, such as described herein. The hydrogen combustor 502 combusts the hydrogen feedstock 506 with the air 510 to produce a nitrogen feedstock 512. The vapor phase water 508-1 remains in the stream and continues with the nitrogen feedstock 512 to the condenser 514.

In some embodiments, the condenser 514 cools the stream of nitrogen feedstock 512 and vapor phase water 508-1 below the boiling temperature of the water (e.g., 100° C. or other boiling temperature relative to a pressure in the condenser), and the condenser 514 passes the nitrogen feedstock 512 and the liquid phase water 508-2 to a separator 572. In some embodiments, the separator 572 is integrated with the condenser 514 in a single component. The separator 572 separates the liquid phase water 508-2 from the nitrogen feedstock 512 and passes the nitrogen feedstock 512 to the compression train 520 while directing the liquid phase water 508-2 to be recycled to other components and/or storage devices in the ammonia production system 500, such as the desalination device, the electrolyzer cell, the thermal energy generation cycle, and thermal management devices, via a water conduit such as a pipe.

In some embodiments, the combustion products (e.g., water and contaminants) remaining after combustion are returned to the steam generator, recycling at least a portion of the combustion heat. In some embodiments, the condenser 514 is integrated with a steam generation device heat exchanger. Additional cooling may be provided by a low-temperature thermal storage device. The separator 572 may be further integrated with the condenser 514 and the steam generator for the efficient separation of gaseous nitrogen feedstock 512 from the water in the combustion stream.

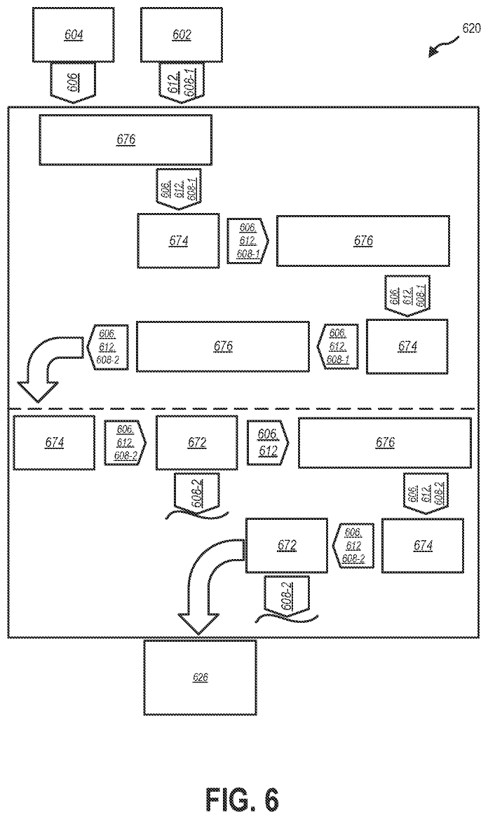

FIG. 6 is a detail flowchart of an embodiment of a compression train 620 including separators 672 to separate liquid phase water 608-2 from the feedstock gases (e.g., hydrogen feedstock 606 and nitrogen feedstock 612). In some embodiments, the compression train 620 receives hydrogen feedstock 606 from the electrolyzer cell 604 and nitrogen feedstock 612. The Haber-Bosch ammonia synthesis cycle conventionally uses a catalyzed reaction of hydrogen feedstock 606 and nitrogen feedstock 612 over a catalyst at high pressures (e.g., 2500-3500 pounds per square inch) and high temperatures (e.g., 300-500° C.). To produce the high-pressure hydrogen feedstock 606 and nitrogen feedstock 612 stream at the inlet of the catalyst contactor, a compression train 620 is, in some embodiments, used to compress the gases with an associated adiabatic compression heat produced as a byproduct. The heat generated by increasing the pressure of this gas stream (combined or separate), is comparable to steam energy requirement for the electrolyzer cell process, and at least a portion of the compression heat can be transferred to the steam generator to recycle the heat.

Conventionally, a compression train would be optimized for the lowest quantity of cycles to reach the pressure require. In some embodiments according to the present disclosure, a compression train 620 has five or more cycles to keep the minimum temperature consistent in each cycle and produce a heatload from each cycle that can be used for steam generation. In some embodiments, the heatload remains above 105° C. at one or more compressors 676 and/or coolers 674 in the compression train 620. In some embodiments, the heatload remains above 105° C. at all compressors 676 and/or coolers 674 in the compression train 620. In some embodiments, the ammonia production system includes one or more cooler thermal conduits to provide thermal transfer (e.g., transfer heat) from the cooler(s) 674 to the steam generation device. In some embodiments, the ammonia production system includes one or more cooler thermal conduits to recycle the compression heat by transferring compression heat from the cooler(s) 674 to a thermal storage device.

In some embodiments, the compression train 620 includes a series of compressors 676 and coolers 674 to serially compress the feedstock stream (which produces an associated adiabatic compression heat) and cool the feedstock stream as it heats during compression. In some embodiments, the input stream (e.g., from the hydrogen combustor 602) includes vapor phase water 608-1. The vapor phase water 608-1 is compressed and cooled through the compression train until the compression exceeds the vapor pressure of water at the temperature of the water. For example, in embodiments where the temperature of the stream remains above 105° C. throughout the compression train, the water will remain above the boiling temperature of water at atmosphere, but the compression train 620 may, at some point, compress the vapor phase water 608-1 pass the vapor pressure of the water at (or above) 105° C., and the vapor phase water 608-1 will condense into a liquid phase water 608-2. After compressing the water past the vapor pressure, the liquid phase water 608-2 is, in some embodiments, removed from the feedstock stream through one or more separators 672. With each compression at a compressor 676, additional water may condense out and be removed with a separator 672. The compressed nitrogen feedstock 612 and hydrogen feedstock 606 is, in some embodiments, provided to the ammonia reactor 626 for ammonia production.

In some embodiments, the minimum temperature of the stream in the compression train 620 (or at one or more compressors 676 and/or coolers 674 in the compression train 620) is greater than 105° C. For example, the minimum temperature may be 110° C., 115° C., 120° C., 130° C. or another temperature that is greater than a boiling temperature of the water in the electrolyzer cell. In at least one example, the electrolyzer cell may be configured to operate at an elevated pressure, and the boiling temperature of water at the elevated pressure may be 130° C. A minimum temperature of the stream in the compression train 620 greater than the boiling temperature of water at the elevated pressure may ensure the compression heat recycled to the electrolyzer cell heats the electrolyzer cell above the boiling temperature of the water being electrolyzed.

The compression train 620 described herein is not the most efficient for compression, as the compression train 620 maintains the temperature of some or all of the compression cycles to 105° C. or more. However, maintaining the temperature above a threshold value with a greater quantity of compression cycles, in some embodiments, allows the reject heat to be recovered and used directly for steam generation, without additional electrical heating equipment and cooling tower to discharge waste heat. Any additional heat, not required at the electrolyzer cell or steam generator can be directed to the energy storage in the thermal system, and stored for later use, either as heat in a thermal storage device or electricity in an electrical storage device.

In at least some embodiments of the present disclosure, an ammonia production system, or subsystems thereof, uses a hydrogen combustor to produce nitrogen feedstock gas for ammonia production. The ammonia production system, or subsystems thereof, recycles at least a portion of produced heat and electricity to reduce the overall energy consumption and carbon usage of the ammonia production system.

### INDUSTRIAL APPLICABILITY

The present disclosure relates generally to embodiments of an ammonia production system utilizing electricity and heat recapture and recycling from a hydrogen combustor to one or more stages of the ammonia production process. For example, a hydrogen combustor can combust a portion of available hydrogen in combination with air to produce heat, electricity, and a nitrogen feedstock. The heat and electricity from the nitrogen feedstock production can be recycled back to a renewable energy source or to a solid-oxide electrolysis cell (SOEC) to produce energy or reduce energy consumption.

In some embodiments, an ammonia production system reacts hydrogen feedstock (e.g., H₂) with a nitrogen feedstock (e.g., N₂) to produce ammonia (NH₃) in a reactor at an elevated temperature. For example, the reaction may be conducted at pressures above 10 MPa (100 bar; 1,450 psi) and between 400 and 500° C. (752 and 932° F.). In some embodiments, the gases (nitrogen and hydrogen) are passed over beds of catalyst, with cooling between each pass for maintaining a reasonable equilibrium constant. In some examples, a partial conversion is achieved on each pass (e.g., about 15% conversion), but any unreacted gases are recycled through the reactor, and eventually an overall conversion of 97% of feedstock gases can be achieved. In some embodiments, the catalyst consists of iron bound to an iron oxide carrier containing promoters such as aluminium oxide, potassium oxide, calcium oxide, potassium hydroxide, molybdenum, magnesium oxide, other materials, or combinations thereof.

Producing the feedstock gases for the reaction conventionally requires an external power source and can consume large amounts of electricity. Some embodiments of ammonia production systems according to the present disclosure can capture and recycle heat and electricity from within the system to reduce energy consumption. Some embodiments of ammonia production systems according to the present disclosure can include variable renewable energy (VRE) sources or imported off-peak electricity to further reduce carbon by-products of the system. In some embodiments, electricity and/or heat from the system is recycled to the VRE sources to further reduce energy consumption of the system.

In a conventional ammonia production system, nitrogen feedstock gas is produced through either membrane separation of pressure swing adsorption, both of which consume electricity to produce the nitrogen feedstock. In some embodiments according to the present disclosure, a hydrogen combustor is used to combust hydrogen gas in the presence of air to produce a nitrogen feedstock in an exothermic reaction. In some examples, heat from the exothermic reaction is recycled to vaporize water (in preparation for electrolysis of the water). In some examples, the exothermic reaction can drive a turbine or internal combustion engine to produce electricity, which is used to power the electrolysis of the water. The heat and electricity by-products of the hydrogen combustion can, thereby, offset at least a portion of the energy consumed during production of the hydrogen feedstock.

In other examples, heat from hydrogen combustor can be recycled to the ammonia reactor (i.e., the Haber-Bosch reactor) to produce the elevated temperatures for the Haber-Bosch reaction. In yet other examples, heat from the hydrogen combustor can be recycled to a VRE source, such as a low-temperature (e.g., 90° C. or less) solar thermal generator to assist in producing electricity for the ammonia production system. In yet further examples, waste heat from the Haber-Bosch reaction can be recycled to vaporize water for electrolysis and/or for electricity production in a VRE source.

In some embodiments, the ammonia production system includes a hydrogen combustor. A solid-oxide electrolysis cell (SOEC) provides hydrogen (H₂) feedstock and water (H₂O) to the hydrogen combustor. The hydrogen combustor combusts at least a portion of the hydrogen feedstock with air in an exothermic reaction to produce heat and electricity. The combustion results in products including nitrogen feedstock that is exhausted with water to a condenser. In some embodiments, the condenser condenses and removes at least a portion of the water from the input gases (e.g., the nitrogen feedstock and water). The wastewater condensed by the condenser may be recycled elsewhere in the ammonia production system.

In some embodiments, the hydrogen combustor includes a turbine generator that converts an expansion of the combustion reaction into electricity through the rotation of a shaft coupled to the turbine(s). In some embodiments, the hydrogen combustor includes an internal combustion generator that converts an expansion of the combustion reaction within one or more cylinders into electricity through the rotation of a shaft coupled to a piston moveable within the cylinder(s). The hydrogen combustor may convert the expansion of the gases during the combustion reaction into electricity in any relevant manner.

The heat produced by the hydrogen combustor, in some embodiments, is provided to one or more of a thermal power generation cycle, a steam generator, or other components of the ammonia production system. The heat from the hydrogen combustor is provided to the thermal power generation cycle, steam generator, or other component to reduce the amount of energy consumed to heat the respective components. For example, a steam generator may use resistive heating that consumes electricity to heat one or more heating elements through a resistance in the heating element, which dissipates at least a portion of the electrical power as heat. Resistive heating can consume a large amount of electricity. Using waste heat from other components of the ammonia production system, such as the hydrogen combustor, can reduce and/or eliminate the electricity consumption of the steam generator.

In other examples, a thermal power generation cycle may use heat to generate electricity, allowing waste heat from the hydrogen combustor and/or other components of the ammonia production system to be converted into electricity. For example, the electricity produced by the thermal power generation cycle may be provided to the SOEC.

In some embodiments, electricity is further provided to a compression train that compresses one or more feedstock gases (e.g., hydrogen feedstock and nitrogen feedstock). In some embodiments, the feedstock gases are in a single mass flow from the SOEC and the condenser, and the feedstock gases may be compressed in the compression train together in a shared volume. In some embodiments, the feedstock gases may be compressed in separate compression trains. For example, the compressibility of the feedstock gases may be different, and different quantity of compression steps or different compression ratios at each compression steps may be different for the different feedstock gases. As will be described herein, in some embodiments, a compression train according to the present disclosure may maintain a temperature of the feedstock gases above a selected temperature to allow recycling of heat from the compressor(s) of the compression train to the steam generator or other components of the ammonia production system.

In some embodiments, the SOEC produces hydrogen feedstock from water that is supplied by a steam generator. The steam generator heats the water above the boiling temperature to produce steam that is provided to the SOEC. In some embodiments, the steam generator includes resistive heating elements to heat the water. In some embodiments, the steam generator heats the water with a heat pump. In some embodiments, the steam generator consumes less energy than a conventional ammonia production system by recycling at least a portion of the heat produced elsewhere in the ammonia production system to heat and/or vaporize the water.

In some embodiments, the ammonia production system further includes a desalination device. For example, the desalination device may receive input water from a saline source, such as ocean water, and desalinate the water for use in the ammonia production system. In some embodiments, the desalination device provides water to the steam generator to produce steam that is more easily electrolyzed by the SOEC. In some embodiments, desalinated water is used to fill an energy storage system, provided a coolant in heat exchange cycles, provide water to the thermal power generation cycle, provide water to the steam generator, or combinations thereof. Desalination to the target requirement of SOEC's has a significant energy requirement that can be delivered by a VRE source, from the thermal power generation cycle, through a Reverse Osmosis (RO) process, through supplemental heat recycled from other components of the ammonia production system, or combinations thereof. Thermal desalination is, therefore, an opportunity to recycle heat from thermal storage or other components of the ammonia production system to provide at least a portion of the required energy load for desalination.

For example, there are at least two methods that can be integrated into a combined progress, which each provide additional energy efficiency through the use of either heat or electricity. The specific VRE source may affect the amount of heat recycled to the desalination. In some examples, as the balance of generation from a concentrated solar thermal generator shifts toward more electricity, or more thermal capacity per square-meter of receiver area, a surplus of either may emerge. A future increase in photovoltaic efficiency may favor more electricity, driving the use of a more economical RO processes. If the thermal tolerance of photovoltaic cells improves at a proportionally higher rate in the future, an increase in temperature and heat load may favor thermal desalination.

After producing the hydrogen feedstock and the nitrogen feedstock, an ammonia production system may include an ammonia reactor (such as a Haber-Bosch reactor) or other reactor to produce ammonia. The ammonia may then be delivered to an ammonia storage device for distribution, packaging, further treatment, or combination with other produces.

In some embodiments, the ammonia is the final product of the ammonia production system. For example, the ammonia can be exported or combusted to generate energy on demand for the process or network electricity demand. In some embodiments, the ammonia production system is part of a production system for another product, and the ammonia is provided as a part of another product.

In some embodiments according to the present disclosure, only the Haber-Bosch synthesis loop is required, with nitrogen feedstock and hydrogen feedstock fed by the SOEC and hydrogen combustor and the heating and compression train powered by the VRE source.

The ammonia reactor, in some embodiments, produces heat that is recycled to other components of the ammonia production system. In some embodiments, an exothermic reaction across an iron-based catalyst bed creates a high temperature discharge stream from the reactor. This high temperature heat load at ˜500° C. discharged from the reactor is recycled into the working fluid in the thermal cycle, as superheat, with the residual heatload used for preheating the compressed feedstock (e.g., nitrogen feedstock and hydrogen feedstock) stream from the compression train to the ammonia reactor. Further cooling requirements for the nitrogen feedstock, hydrogen feedstock, and ammonia stream(s) are provided by a low temperature chiller, with the rejected heat returned to the hot storage. The thermal storage system further improves the exchange efficiency.

In some embodiments, ammonia is separated through a multistage separator in or after the ammonia reactor, which allows nitrogen feedstock and hydrogen feedstock 106 to be recycled back into the compression train, for reprocessing. The typical single pass Haber-Bosch reactor yield is between 12 and 18%. Further development of catalysts and electrolytic cells may improve the yield value further. Further advances in both conversion options provide further efficiency to drive down the levelized cost of ammonia according to the present disclosure. The utilization of the exothermic heat recycled back into the thermal power generation cycle and other components of the ammonia production system to boost efficiency of the ammonia production system allows less energy consumption and lower cost of operations compared to a conventional Haber-Bosch synthesis loop production system.

In some embodiments, heat is recycled from a heat source component to a heat sink component in the ammonia production system directly through a thermal conduit. A heat source component is any component of the ammonia production system that produces heat and/or has heat produced therein during operation, such as by an exothermic reaction. For example, a heat source component includes the hydrogen combustor, the compression train, the ammonia reactor, and the VRE source. A heat sink component is any component of the ammonia production system that receives heat or consumes heat during operation. For example, a heat sink component includes the steam generator, the thermal energy generation cycle, and the desalination device. In some examples, a component may selectively be a heat source component and/or a heat sink component, such as the ammonia reactor which can be heated prior to a Haber-Bosch cycle but also produces heat through the exothermic reaction. In some embodiments, the ammonia reactor can receive heat to preheat the ammonia reactor and then export heat after the exothermic reaction.

In some embodiments, the heat is transferred from a heat source component to a heat sink component through a thermal conduit that conducts heat and/or transfers heat through a mass flow. For example, some thermal conduits may be a solid-state thermal conduit that conduct heat through thermally conductive solid mass, such as a rod or sheet between the heat source component and the heat sink component. In some examples, the thermal conduit is a solid copper conduit. In other examples, some thermal conduits may be a fluid-based conduit that flows a working fluid through and/or in at least a portion of the conduit to move heat from the heat source component and the heat sink component. For example, the working fluid may be water. In other examples, particularly those transferring heat from a heat source component with a temperature above the boiling temperature of water, the working fluid may be a different working fluid with a higher boiling temperature to allow the working fluid to remain liquid while transferring heat. In yet other examples, the working fluid may be a multi-phase working fluid that changes physical state during the heat transfer process. As the latent heat of boiling allows the working fluid to receive additional heat without an associated increase in temperature, a multi-phase working fluid can further increase the heat transfer efficiency of a thermal conduit.

In some embodiments, one or more of the thermal conduits that move heat from a heat source component to a heat sink component is a dedicated conduit. For example, the thermal conduit is configured to move heat only from a heat source component to a heat sink component. In some embodiments, one or more of the thermal conduits that move heat from a heat source component to a heat sink component is a shared conduit. For example, the thermal conduit is configured to transfer heat from a plurality of heat source components to a single heat sink component, from a single heat source component to a plurality of heat sink components, or from a plurality of heat source components to a plurality of heat sink components.

In some embodiments, heat is recycled from a heat source component to a heat sink component in the ammonia production system indirectly through a thermal storage device. For example, a thermal storage device may be positioned in or along any of the thermal conduits that receives heat from a heat source component and stores the heat for subsequent transfer to a heat sink component. In some embodiments, one or more thermal storage devices are dedicated thermal storage devices. For example, the dedicated thermal storage device is positioned in or along a dedicated thermal conduit. In some embodiments, one or more thermal storage devices are shared thermal storage devices. For example, the shared thermal storage device is positioned in or along a shared thermal conduit.

One or more electrical conduits, in some embodiments, are configured to provide electrical communication between an electrical source component and an electrical sink component. In some embodiments, one or more of the electrical conduits that move electricity from an electrical source component to an electrical sink component is a dedicated conduit. For example, the electrical conduit is configured to provide electricity only from an electrical source component to an electrical sink component. In some embodiments, one or more of the electrical conduits that conduct electricity from the electrical source component to the electrical sink component is a shared electrical conduit. For example, the electrical conduit is configured to transfer electricity from a plurality of electrical source components to a single electrical sink component, from a single electrical source component to a plurality of electrical sink components, or from a plurality of electrical source components to a plurality of electrical sink components.

In some embodiments, electricity is recycled from an electrical source component to an electrical sink component in the ammonia production system indirectly through an electrical storage device, such as a battery, capacitor, or other electrical storage device. For example, an electrical storage device may be positioned in or along any of the electrical conduits that receives electricity from an electrical source component and stores the electricity for subsequent transfer to an electrical sink component. In some embodiments, one or more electrical storage devices are dedicated electrical storage devices. For example, the dedicated electrical storage device is positioned in or along a dedicated electrical conduit. In some embodiments, one or more electrical storage devices are shared electrical storage devices. For example, the shared electrical storage device is positioned in or along a shared electrical conduit.

In some embodiments, a method of ammonia production includes producing steam with a steam generating device and delivering the steam to an electrolyzer cell. In some embodiments, the electrolyzer cell is a SOEC such as described herein. The method further includes electrolyzing the steam to form hydrogen gas. In some embodiments, the steam is not fully converted into hydrogen gas and oxygen gas, and at least a portion of the water remains in the electrolyzer cell. The unreacted water may be removed when the other gases are removed from the electrolyzer cell, or the unreacted water may remain in or be recycled back into the electrolyzer cell for further processing.

The method further includes providing the hydrogen gas from the electrolyzer cell to a hydrogen combustor and combusting the hydrogen gas with air to produce nitrogen, water vapor, electricity, and heat. In some embodiments, providing the hydrogen gas to the hydrogen combustor includes dividing the hydrogen gas produced in the electrolyzer cell into a first stream directed to the hydrogen combustor and a second stream directed to a compression train. For example, the first stream of hydrogen gas to the hydrogen combustor may include approximately 50% of the hydrogen gas produced by the electrolyzer cell, while the second stream of hydrogen gas to the compression train includes the remaining approximately 50% of the hydrogen gas. In other examples, the first stream of hydrogen gas to the hydrogen combustor may include less than 50%, such as approximately 15%, of the hydrogen gas produced by the electrolyzer cell, while the second stream of hydrogen gas to the compression train includes the remaining hydrogen gas, such as approximately 85% of the hydrogen gas. In yet other examples, the first stream of hydrogen gas to the hydrogen combustor may include greater than 50%, such as approximately 70%, of the hydrogen gas produced by the electrolyzer cell, while the second stream of hydrogen gas to the compression train includes the remaining hydrogen gas, such as approximately 30% of the hydrogen gas.

In some embodiments, combusting the hydrogen gas with air occurs in a hydrogen combustor including or coupled to an electrical generator that converts an expansion caused by the combustion into electricity. In some examples, the electrical generator converts the expansion into electricity through the expansion rotating a turbine. In some examples, the electrical generator converts the expansion into electricity through the expansion moving pistons that rotate a shaft. The rotation of the turbine and/or shaft can be converted to electricity to produce the electricity.

After the nitrogen, water vapor, electricity, and heat are produced, the method includes recycling at least a portion of the heat to the steam generation device and recycling at least a portion of the electricity to the electrolyzer cell. In some embodiments, recycling the heat to the steam generation device includes transferring the heat through a combustion thermal conduit from the hydrogen combustor to the steam generation device. For example, the combustion thermal conduit may be a dedicated conduit. In other examples, the combustion thermal conduit may be a shared conduit that receives heat from the hydrogen combustor. In yet other examples, the combustion thermal conduit may be a shared thermal conduit that provides heat to the steam generator from at least the hydrogen combustor. In some embodiments, the combustion thermal conduit includes a thermal storage device in or along the combustion thermal conduit that allows heat to be transferred from the hydrogen combustor to the thermal storage device. The thermal storage device may store the heat from the hydrogen combustor for at least some period of time before releasing the heat to the steam generator device.

In some embodiments, recycling at least a portion of the electricity to the electrolyzer cell includes transferring the heat through a combustion electrical conduit from the hydrogen combustor (and/or the electrical generator associated therewith) to the electrolyzer cell. For example, the combustion electrical conduit may be a dedicated electrical conduit. In other examples, the combustion electrical conduit may be a shared electrical conduit that receives electricity from the hydrogen combustor and/or electrical generator. In yet other examples, the combustion electrical conduit may be a shared electrical conduit that provides electricity to the electrolyzer cell from at least the hydrogen combustor and/or electrical generator. In some embodiments, the combustion electrical conduit includes an electrical storage device in or along the combustion electrical conduit that allows electricity to be transferred from the hydrogen combustor and/or electrical generator to the electrical storage device. The electrical storage device may store the electricity from the hydrogen combustor and/or electrical generator for at least some period of time before releasing the electricity to the electrolyzer cell.

In some embodiments, the thermal storage device receives heat from a plurality of heat source components. In some embodiments, a shared thermal storage device receives heat from a reactor thermal conduit and a shared conduit that provides heat from the hydrogen combustor and the compression train. The thermal storage device can store the heat and selective transfer the heat to the steam generation device to heat the steam generation device and reduce and/or eliminate energy consumption by the steam generation device. The steam generation device can then provide the steam to the SOEC, which provides the hydrogen feedstock to the hydrogen combustor. The resulting nitrogen feedstock is provided to the condenser and/or the compression train which compress the feedstock gases before the ammonia reactor that produces the ammonia.

In some embodiments, a plurality of thermal storage devices receives and distribute heat through the ammonia production system, allowing heat flow to be managed in response to demand. In some embodiments, a first thermal storage device is configured to receive heat from the reactor thermal conduit, a second thermal storage device is configured to receive heat from the compressor thermal conduit, and a third thermal storage device is configured to receive heat from the combustion thermal conduit. Each dedicated thermal storage device can selectively provide heat to the steam generation device independently. In some embodiments, the thermal conduits transferring heat from the thermal storage devices and to the thermal storage devices are each dedicated thermal conduits.

In some embodiments, thermal storage device of the ammonia production system includes both high temperature thermal storage device and low temperature thermal storage device. For example, the low temperature thermal storage device may be generated through a chiller, utilizing the energy generation from either the solar thermal generator, photovoltaic panels, wind, or other VRE Source, or imported off-peak electricity. Storage as chilled water, ice slurry, solid storage, or a phase change materials allows the recovery of the stored energy (i.e., heat sink) on demand.

In removing heat from the chilled fluid, the reject heat can be recovered through a heat pump or other heat exchange mechanism and also delivered to the high temperature thermal storage device. Stored heat can be directly exported to heat sink components such as desalination, steam generation, SOEC heating, and reactor pre-heating. Stored chilled solid/fluid/gas can be exported and applied directly in thermal management components within the ammonia production system, such as cooling, condensing, and compression applications.

The thermal energy generation cycle, in some embodiments, produces electricity to power one or more electrical loads in the ammonia production system by converting imported heat from the high temperature thermal storage device, from other heat source components in the ammonia production system, or from VRE sources such as solar thermal generators. The thermal energy generation cycle, in some embodiments, produces electricity based on a temperature difference between a hot portion heated, at least partially, by the imported heat (such as from the high temperature thermal storage device) and a cold portion chilled by, at least partially, the low temperature thermal storage. The thermal storage device(s) may, thereby, allow selective distribution of high or low temperatures to adjust electricity production.

In some embodiments, at least a part of an ammonia production system has a condenser configured to condense vapor phase water into liquid phase water and a separator to recycle liquid phase water to one or more components of the ammonia production system. In some embodiments, air, hydrogen feedstock, and vapor phase water are provided to the hydrogen combustor. For example, the hydrogen feedstock and the vapor phase water may be provided by the SOEC, such as described herein. The hydrogen combusts the hydrogen feedstock with the air to produce a nitrogen feedstock. The vapor phase water remains in the stream and continues with the nitrogen feedstock to the condenser.

In some embodiments, the condenser cools the stream of nitrogen feedstock and vapor phase water below the boiling temperature of the water (e.g., 100° C. or other boiling temperature relative to a pressure in the condenser), and the condenser passes the nitrogen feedstock and the liquid phase water to a separator. In some embodiments, the separator is integrated with the condenser in a single component. The separator separates the liquid phase water from the nitrogen feedstock and passes the nitrogen feedstock to the compression train while directing the liquid phase water to be recycled to other components and/or storage devices in the ammonia production system, such as the desalination device, the electrolyzer cell, the thermal energy generation cycle, and thermal management devices, via a water conduit such as a pipe.

In some embodiments, the combustion products (e.g., water and contaminants) remaining after combustion are returned to the steam generator, recycling at least a portion of the combustion heat. In some embodiments, the condenser is integrated with a steam generation device heat exchanger. Additional cooling may be provided by a low-temperature thermal storage device. The separator may be further integrated with the condenser and the steam generator for the efficient separation of gaseous nitrogen feedstock from the water in the combustion stream.

A compression train includes, in some embodiments, one or more separators to separate liquid phase water from the feedstock gases (e.g., hydrogen feedstock and nitrogen feedstock). In some embodiments, the compression train receives hydrogen feedstock from the electrolyzer cell and nitrogen feedstock. The Haber-Bosch ammonia synthesis cycle conventionally uses a catalyzed reaction of hydrogen feedstock and nitrogen feedstock over a catalyst at high pressures (e.g., 2500-3500 pounds per square inch) and high temperatures (e.g., 300-500° C.). To produce the high-pressure hydrogen feedstock and nitrogen feedstock stream at the inlet of the catalyst contactor, a compression train is, in some embodiments, used to compress the gases with an associated adiabatic compression heat produced as a byproduct. The heat generated increasing the pressure of this gas stream (combined or separate), is comparable to steam energy requirement for the electrolyzer cell process, and at least a portion of the compression heat can be transferred to the steam generator to recycle the heat.

Conventionally, a compression train would be optimized for the lowest quantity of cycles to reach the pressure required. In some embodiments according to the present disclosure, a compression train has five or more cycles to keep the minimum temperature consistent in each cycle and produce a heat from each cycle that can be used for steam generation. In some embodiments, the heat remains above 105° C. at one or more compressors and/or coolers in the compression train. In some embodiments, the heat remains above 105° C. at all compressors and/or coolers in the compression train.

In some embodiments, the compression train includes a series of compressors and coolers to serially compress the feedstock stream (which produces an associated adiabatic compression heat) and cool the feedstock stream as it heats during compression. In some embodiments, the input stream (e.g., from the hydrogen combustor) includes vapor phase water. The vapor phase water is compressed and cooled through the compression train until the compression exceeds the vapor pressure of water at the temperature of the water. For example, in embodiments where the temperature of the stream remains above 105° C. throughout the compression train, the water will remain above the boiling temperature of water at atmosphere, but the compression train may, at some point, compress the vapor phase water pass the vapor pressure of the water at (or above), and the vapor phase water will condense into a liquid phase water. After compressing the water past the vapor pressure, the liquid phase water is, in some embodiments, removed from the feedstock stream through one or more separators. With each compression at a compressor, additional water may condense out and be removed with a separator.

In some embodiments, the minimum temperature of the stream in the compression train 620 (or at one or more compressors 676 and/or coolers 674 in the compression train 620) is greater than 105° C. For example, the minimum temperature may be 110° C., 115° C., 120° C., 130° C. or another temperature that is greater than a boiling temperature of the water in the electrolyzer cell. In at least one example, the electrolyzer cell may be configured to operate at an elevated pressure, and the boiling temperature of water at the elevated pressure may be 130° C. A minimum temperature of the stream in the compression train 620 greater than the boiling temperature of water at the elevated pressure may ensure the compression heat recycled to the electrolyzer cell heats the electrolyzer cell above the boiling temperature of the water being electrolyzed.

The compression train described herein, in some embodiments, is not the most efficient for compression, because the compression train maintains a minimum temperature of some or all of the compression cycles of approximately 105° C. In some embodiments, maintaining a minimum temperature value allows the reject heatload to be recovered and used directly for steam generation, without additional electrical heating equipment and cooling tower to discharge waste heat. Any additional heatload, not required at the electrolyzer cell or steam generator can be directed to the energy storage in the thermal system, and stored for later use, either as heat in a thermal storage device or electricity in an electrical storage device.

The present disclosure relates to systems and methods for ammonia production according to any of the sections below:

[A1] In some embodiments, an ammonia production system includes a steam generation device configured to produce steam and an electrolyzer cell configured to produce hydrogen feedstock gas from the steam. A hydrogen combustor receives at least one part of hydrogen feedstock gas from the electrolyzer cell and combusts the at least one part of hydrogen feedstock gas and produce heat and electricity. A combustion thermal conduit provides heat transfer between the hydrogen combustor and at least one component of the system. An electrical generator is connected to the hydrogen combustor and configured to generate electricity from the combustion.

[A2] In some embodiments, the hydrogen combustor of [A1] further produces nitrogen feedstock gas, and the system further comprises a compression train configured to compress the nitrogen feedstock gas.

[A3] In some embodiments, the compression train of [A1] or [A2] includes a plurality of compressors and at least one cooler, and the cooler is configured to maintain the nitrogen feedstock gas at no less than 105° C.

[A4] In some embodiments, the system of [A3] further includes a cooler thermal conduit configured to provide thermal transfer between the cooler and the at least one component of the system.

[A5] In some embodiments, the hydrogen combustor of any of [A1] through [A4] further produces vapor phase water, and the system further includes a condenser configured to receive the vapor phase water and condense the vapor phase water into liquid phase water.

[A6] In some embodiments, the condenser of [A5] is configured to separate at least a portion of the nitrogen feedstock gas from the liquid phase water.

[A7] In some embodiments, the system of [A6] includes a water conduit configured to provide the liquid phase water to the steam generation device.

[A8] In some embodiments, the system of any of [A1] through [A7] wherein the hydrogen combustor is configured to receive a first part of the hydrogen feedstock, and wherein the system includes an ammonia reactor configured to receive a second part of the hydrogen feedstock gas.

[A9] In some embodiments, the system of any of [A1] through [A8] includes a combustion electrical conduit that provides electrical communication between the electrical generator and the electrolyzer cell.

[A10] In some embodiments, the system of any of [A1] through [A9] further comprises a variable renewable energy (VRE) source configured to provide electricity to at least one component of the system.

[A11] In some embodiments, the VRE source of [A10] includes at least one of a photovoltaic, solar thermal, wind, and geothermal energy source.

[A12] In some embodiments, the system of [A10] or [A11] is configured to convert heat from the VRE source into electricity using a thermal energy generation cycle.

[B1] In some embodiments, a method of producing ammonia includes producing steam with a steam generation device; delivering the producing processed water product with a water treatment unit, wherein producing the processed water product is one of producing steam with a steam generation device and producing desalinated water with a desalination device; delivering the processed water product to an electrolyzer cell; electrolyzing the processed water product to form hydrogen gas; providing at least part of the hydrogen gas from the electrolyzer cell to a hydrogen combustor; combusting said part of the hydrogen gas with air to produce nitrogen feedstock, water, electricity, and heat; recycling the heat to the water treatment unit; and recycling the electricity to the electrolyzer cell.

[B2] In some embodiments, recycling the heat to the water treatment unit, for instance steam generation device or the desalination unit, of [B1] includes receiving the heat at a thermal storage device.

[B3] In some embodiments, recycling the electricity to the electrolyzer cell of [B1] or [B2] includes receiving the electricity at an electrical storage device.

[B4] In some embodiments, the electrical storage device of [B3] is a battery.

[B5] In some embodiments, the method of any of [B1] through [B4] includes recycling the water to the steam generation device.

[B6] In some embodiments, the method of any of [B1] through [B5] further including: compressing the nitrogen feedstock; and recycling compression heat from the nitrogen feedstock to the steam generation device.

[B7] In some embodiments, the method of any of [B1] through [B6] further comprises providing electricity to at least one component of the system using a VRE source.

[B8] In some embodiments, the VRE source of [B7] includes at least one of a photovoltaic, solar thermal, wind, and geothermal energy source.

[B9] In some embodiments, the method of [A10] or [A11] includes converting heat from the VRE source into electricity using a thermal energy generation cycle.

[C1] In some embodiments, a system for ammonia production includes a thermal energy generation cycle, a steam generation device, and an electrolyzer cell. The thermal energy generation cycle is configured to produce electricity. The steam generation device is configured to produce steam. The electrolyzer cell is configured to produce hydrogen feedstock gas from the steam. A hydrogen combustor is configured to receive the hydrogen feedstock gas from the electrolyzer cell and combust the hydrogen feedstock gas and produce nitrogen feedstock gas, heat, and electricity. A first combustion thermal conduit provides thermal transfer between the hydrogen combustor and the steam generation device. A second combustion thermal conduit that provides thermal transfer between the hydrogen combustor and the thermal energy generation cycle. An electrical generator is connected to the hydrogen combustor and generates electricity from the combustion performed by the hydrogen combustor. An ammonia reactor is configured to receive the hydrogen feedstock gas and the nitrogen feedstock gas.

[C2] In some embodiments, the thermal energy generation cycle of [C1] is configured to receive heat from a solar thermal generator.

[C3] In some embodiments, the thermal energy generation cycle of [C1] or [C2] operates with an operating temperature of no more than 100° C.

[C4] In some embodiments, the system of any of [C1] through [C3] further includes a compression train includes a plurality of compressors configured to compress at least one of the nitrogen feedstock gas and the hydrogen feedstock gas, and the compression train is configured to transfer compression heat from the at least one of the nitrogen feedstock gas and the hydrogen feedstock gas to the steam generation device.

[C5] In some embodiments, at least one of the nitrogen feedstock gas and the hydrogen feedstock gas of [C4] is above 105° C. throughout the compression train.

[D1] In some embodiments, the disclosure related to a system for ammonia production, the system comprising an electrolyzer cell configured to produce hydrogen feedstock gas; a hydrogen combustor configured to receive the hydrogen feedstock gas from the electrolyzer cell and combust the hydrogen feedstock gas and produce heat; an electrical generator connected to the hydrogen combustor and configured to generate electricity using the combustion performed by the hydrogen combustor; and a combustion thermal conduit that provides thermal transfer between the hydrogen combustor and at least one of the component of the system.

[D2] In some embodiments, the system of [D1] further includes a steam generation device configured to produce steam, wherein the electrolyzer cell is configured to produce hydrogen feedstock gas from the steam and wherein at least one of the combustion thermal conduit provides thermal transfer between the combustor and steam generation device.

[D3] In some embodiments, the system of [D1] or [D2] further includes a thermal desalination device for desalinating water, wherein at least one of the combustion thermal conduit provides thermal transfer between the combustor and the thermal desalination device.

[D4] In some embodiments, the system of any of [D1] through [D3], wherein the thermal desalination device provides desalinated water to the electrolyzer or the steam generation device.

[D5] In some embodiments, the system of any of [D1] through [D4], further comprising a thermal storage system, wherein the combustion thermal conduit provides thermal transfer between the hydrogen combustor and the thermal storage system.

[D6] In some embodiments, the system of any of [D1] through [D5], further comprising a thermal generation cycle, wherein the combustion thermal conduit provides thermal transfer between the hydrogen combustor and the thermal generation cycle. In such system, the thermal energy generation cycle may be configured to receive heat from a solar thermal generator. The thermal energy generation cycle may operate with an operating temperature of no more than 100° C.

[D7] In some embodiments, the system of any of [D1] through [D6], further comprising an electrical generator connected to the hydrogen combustor and configured to generate electricity using the combustion performed by the hydrogen combustor; and a combustion electrical conduit that provides electrical communication between the electrical generator and a component of the system.

[D8] In some embodiments, the system of any of [D1] through [D7], the hydrogen combustor further produces vapor phase water, and the system further comprises a condenser configured to receive the vapor phase water and condense the vapor phase water into liquid phase water. In such embodiment, the hydrogen combustor may further produce nitrogen feedstock gas. The condenser may also be configured to separate at least a portion of the nitrogen feedstock gas from the liquid phase water. Such system may also include a water conduit configured to provide the liquid phase water to the steam generation device.

[D9] In some embodiments, the system of any of [D1] through [D8] comprises an ammonia reactor configured to receive at least part of the hydrogen feedstock gas.

In at least some embodiments of the present disclosure, an ammonia production system, or subsystems thereof, uses a hydrogen combustor to produce nitrogen feedstock gas for ammonia production. The ammonia production system, or subsystems thereof, recycles at least a portion of produced heat and electricity to reduce the overall energy consumption and carbon usage of the ammonia production system.

While embodiments disclosed herein may be used in the ammonia production environments, such environments are merely illustrative. Systems, tools, assemblies, methods, devices, and other components of the present disclosure, or which would be appreciated in view of the disclosure herein, may be used in other applications and environments. In other embodiments, embodiments of the present disclosure may be used outside of an ammonia production environment, including in connection with the production of other compounds and, particularly, nitrogen-bearing compounds, or in the automotive, aquatic, aerospace, hydroelectric, manufacturing, or telecommunications industries.

In the description herein, various relational terms may be used to facilitate an understanding of various aspects of some embodiments of the present disclosure. Relational terms such as “bottom,” “below,” “top,” “above,” “back,” “front,” “left,” “right,” “rear,” “forward,” “up,” “down,” “horizontal,” “vertical,” “clockwise,” “counter clockwise,” “upper,” “lower,” and the like, may be used to describe various components, including their operational or illustrated position relative to one or more other components. Relational terms do not indicate a particular orientation for each embodiment within the scope of the description or claims but are intended for convenience in facilitating reference to various components. Thus, such relational aspects may be reversed, flipped, rotated, moved in space, placed in a diagonal orientation or position, placed horizontally or vertically, or similarly modified.

Certain descriptions or designations of components as “first,” “second,” “third,” and the like are also used to differentiate between identical components or between components which are similar in use, structure, or operation. Such language is not intended to limit a component to a singular designation or require multiple components. As such, a component referenced in the specification as the “first” component may be the same or different than a component that is referenced in the claims as a “first” component, and a claim may include a “first” component without requiring the existence of a “second” component.

Furthermore, while the description or claims may refer to “an additional” or “other” element, feature, aspect, component, or the like, it does not preclude there being a single element, or more than one, of the additional element. Where the claims or description refer to “a” or “an” element, such reference is not be construed that there is just one of that element but is instead to be inclusive of other components and understood as “at least one” of the element. It is to be understood that where the specification states that a component, feature, structure, function, or characteristic “may,” “might,” “can,” or “could” be included, that particular component, feature, structure, or characteristic is provided in certain embodiments, but is optional for other embodiments of the present disclosure. The terms “couple,” “coupled,” “connect,” “connection,” “connected,” “in connection with,” and “connecting” refer to “in direct connection with,” or “in connection with via one or more intermediate elements or members.” Components that are “integral” or “integrally” formed include components made from the same piece of material, or sets of materials, such as by being commonly moulded or cast from the same material, in the same moulding or casting process, or commonly machined from the same piece of material stock. Components that are “integral” should also be understood to be “coupled” together.

Additionally, references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

Although various example embodiments have been described in detail herein, those skilled in the art will readily appreciate in view of the present disclosure that many modifications are possible in the example embodiments without materially departing from the present disclosure. Accordingly, any such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The Abstract at the end of this disclosure is provided to allow the reader to quickly ascertain the general nature of some embodiments of the present disclosure. It is submitted with the understanding that it will not be used to interpret or limit the scope or meaning of the claims.

What is claimed is:

1. A system for ammonia production, the system comprising:
an electrolyzer cell configured to produce hydrogen feedstock gas;
a hydrogen combustor configured to receive at least a part of the hydrogen feedstock gas from the electrolyzer cell and combust said part of the hydrogen feedstock gas and produce heat;
an electrical generator connected to the hydrogen combustor and configured to generate electricity using the combustion performed by the hydrogen combustor; and
a combustion electrical conduit that provides electrical communication between the electrical generator and a component of the system.

2. The system of claim 1, further including a steam generation device configured to produce steam, wherein the electrolyzer cell is configured to produce hydrogen feedstock gas from the steam.

3. The system of claim 1, wherein the hydrogen combustor further produces vapor phase water, and the system further comprises a condenser configured to receive the vapor phase water and condense the vapor phase water into liquid phase water.

4. The system of claim 3, wherein the hydrogen combustor further produces nitrogen feedstock gas and wherein the condenser is configured to separate at least a portion of the nitrogen feedstock gas from the liquid phase water.

5. The system of claim 1, wherein the at least one part of the hydrogen feedstock is a first part of the hydrogen feedstock, further comprising an ammonia reactor configured to receive a second part of the hydrogen feedstock gas.

6. The system of claim 1, further comprising a combustion thermal conduit that provides thermal transfer between the hydrogen combustor and a component of the system.

7. The system of claim 1, further comprising a thermal energy generation cycle.

8. The system of claim 7, wherein the thermal energy generation cycle is configured to receive heat from a solar thermal generator.

9. The system of claim 8, wherein the thermal energy generation cycle operates with an operating temperature of no more than 100° C.

10. The system of any of claim 7, wherein at least a combustion thermal conduit that provides thermal transfer between the hydrogen combustor and at least one of the steam generation device, a thermal energy storage, the thermal energy generation cycle, and thermal desalination device.

11. A method of producing ammonia, the method comprising:
producing processed water product with a water treatment unit, wherein producing the processed water product is one of producing steam with a steam generation device and producing desalinated water with a desalination device;
delivering the processed water product to an electrolyzer cell;
electrolyzing the processed water product to form hydrogen gas;
providing at least part of the hydrogen gas from the electrolyzer cell to a hydrogen combustor;
combusting said part of the hydrogen gas with air to produce nitrogen feedstock, water, electricity, and heat;
recycling the heat to the water treatment unit; and
recycling the electricity to the electrolyzer cell.

12. The method of claim 11, wherein recycling the heat to the water treatment unit includes receiving the heat at a thermal storage device.

13. The method of claim 11, further comprising providing electricity to at least one of the steam generation device and the electrolyzer cell using a variable renewable energy (VRE) source.

14. The method of claim 11, further comprising converting heat from the VRE source into electricity using a thermal energy generation cycle.

15. A system for ammonia production, the system comprising:
an electrolyzer cell configured to produce hydrogen feedstock gas;
a hydrogen combustor configured to receive at least part of the hydrogen feedstock gas from the electrolyzer cell and combust said part of the hydrogen feedstock gas and produce heat;
an electrical generator connected to the hydrogen combustor and configured to generate electricity using the combustion performed by the hydrogen combustor; and
a combustion thermal conduit that provides thermal transfer between the hydrogen combustor and at least one of the component of the system.

16. The system of claim 15, further including one or more of a steam generation device configured to produce steam, wherein the electrolyzer cell is configured to produce hydrogen feedstock gas from the steam and wherein at least one of the combustion thermal conduit provides thermal transfer between the combustor and steam generation device.

17. The system of claim 15, further comprising a thermal desalination device for desalinating water, wherein at least one of the combustion thermal conduit provides thermal transfer between the combustor and the thermal desalination device.

18. The system of claim 17, wherein the thermal desalination device provides desalinated water to the electrolyzer or the steam generation device.

19. The system of claim 15, further comprising a thermal storage system, wherein the combustion thermal conduit provides thermal transfer between the hydrogen combustor and the thermal storage system.

20. The system of claim 15, further comprising a thermal generation cycle, wherein the combustion thermal conduit provides thermal transfer between the hydrogen combustor and the thermal generation cycle.
